(19) United States
(12) Patent Application Publication
(10) Pub. No.: US 2016/0198130 A1
(43) Pub. Date: Jul. 7, 2016

(54) SURVEILLANCE METHOD AND SURVEILLANCE SYSTEM

(71) Applicant: VIVOTEK INC., New Taipei (TW)

(72) Inventor: Chih-Chiang Chen, New Taipei (TW)

(21) Appl. No.: 14/971,247

(22) Filed: Dec. 16, 2015

(30) Foreign Application Priority Data
Jan. 7, 2015 (TW) 104100442

(51) Int. Cl. H04N 7/18; G06T 3/00; G06K 9/00; H04N 5/262

(52) U.S. Cl. CPC H04N 7/183; H04N 7/188; H04N 5/2628; G06T 3/0018; G06K 9/00771

(57) ABSTRACT

A surveillance method for monitoring a space, which is divided into sub-spaces to be monitored, by a camera. The sub-space to be monitored has at least one preset region. The method includes the following steps. Display an image of one of the preset regions on a screen in a preset time. Determine whether an object is in the preset region, when the image is displayed on the screen. If the object is in the preset region in the preset time, the camera tracks the object in the sub-space to be monitored corresponding to the preset region until the object matches a preset condition. Determine whether the preset time is expired. If the preset time is not expired, display the image of the preset region on the screen. If the preset time is expired, display the image of another of the preset regions on the screen.

### CROSS-REFERENCE TO RELATED APPLICATIONS

This non-provisional application claims priority under 35 U.S.C. §119(a) on Patent Application No(s). 104100442 filed in Taiwan, R.O.C. on Jan. 7, 2015, the entire contents of which are hereby incorporated by reference.

### TECHNICAL FIELD

The disclosure relates to a surveillance method and a surveillance system, more particularly to a surveillance method adapted to a surveillance camera, and a surveillance system thereof.

### BACKGROUND

Modern surveillance cameras are mainly sorted into mechanical cameras and wide-angle cameras. A mechanical camera changes its capturing direction through the control of its inner motor, and a wide-angle camera has a wide-angle lens. Because a mechanical camera captures only a fraction of a space per time point, the mechanical camera has a patrol mode and uses its field of view to patrol these patrol points according to a preset order of patrol points in order to monitor an entire space.

A wide-angle camera can monitor a whole area of a space, so it will not miss any objects during its object tracking. In contrast, a mechanical camera having an object tracking function may miss an object at a preset patrol point when the field of view of the mechanical camera diverts from focusing on the preset patrol point to focusing on a certain unnecessary point after intentionally being shifted, or when the object appears at a certain patrol point on which the mechanical camera does not focus yet. The above situations that modern surveillance cameras, supporting the above patrol mode, face should be resolved.

### SUMMARY

The disclosure provides a surveillance method and a surveillance system in order to avoid missing any suspicious object which a mechanical camera only capturing images of a fixed number of patrol points should monitor, or to efficiently prevent that the field of view of the mechanical camera, having the object tracking function, is intentionally moved by someone to divert from focusing on a preset patrol point to focusing on a certain unnecessary point.

An embodiment of the surveillance method is adapted to monitor a space by a surveillance camera. The space is divided into sub-spaces to be monitored, and each of the sub-spaces to be monitored includes at least one preset region. The surveillance camera can capture images of the preset regions in the sub-spaces to be monitored, and the images are displayed on a display screen. The surveillance method includes the following steps. Display the image of one of the preset regions on the display screen during a preset time period. Determine whether an object exists in the preset region when the image of the preset region is being displayed on the display screen. When the object exists in the preset region during the preset time period, the surveillance camera will keep tracking the object existing in the sub-space to be monitored until the object matches a preset condition. Determine whether the preset time period ends. Keep displaying the image of the preset region on the display screen when the preset time period has not ended. Display the image of another of the preset regions on the display screen when the preset time period ends.

An embodiment of the surveillance system adapted to monitor a space. The space is divided into sub-spaces to be monitored, and each of the sub-spaces to be monitored includes at least one preset region. The surveillance system includes a surveillance camera and a processor. The processor is electrically connected to the surveillance camera. The surveillance camera can capture images of the preset regions. The processor can perform the above surveillance method and control the surveillance camera to track the object existing in the sub-space to be monitored.

As described above, the surveillance method and the surveillance system, promoted in the disclosure, can be applied to mechanical cameras or wide-angle cameras, working as surveillance cameras. The surveillance camera is used to monitor a space including multiple preset regions. When the preset regions are under surveillance, a display screen displays the image of one of the preset regions per a preset time period. Also, the disclosure unceasingly determines whether the preset time period corresponding to the display of the image of the preset region on the display screen ends, so as to decide whether to display the image of another of the preset regions on the display screen or continuously display the image of the current preset region on the display screen. Moreover, when the display screen decides to continuously display the image of the current preset region, a decision whether an object exists in the current preset region is made. Therefore, the surveillance camera can track the object in a suitable range until the object matches a certain preset condition.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram of a surveillance system in an embodiment;

FIG. 2 is a flow chart of a surveillance method in an embodiment;

FIG. 3 is a flow chart of a surveillance method in yet another embodiment;

FIG. 4 is a flow chart of a surveillance method in yet another embodiment;

FIG. 5 is a flow chart of a surveillance method in yet another embodiment;

FIG. 6 is a flow chart of a surveillance method in yet another embodiment;

FIG. 7 is a flow chart of a surveillance method in yet another embodiment; and

FIG. 8 is a flow chart of a surveillance method in yet another embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

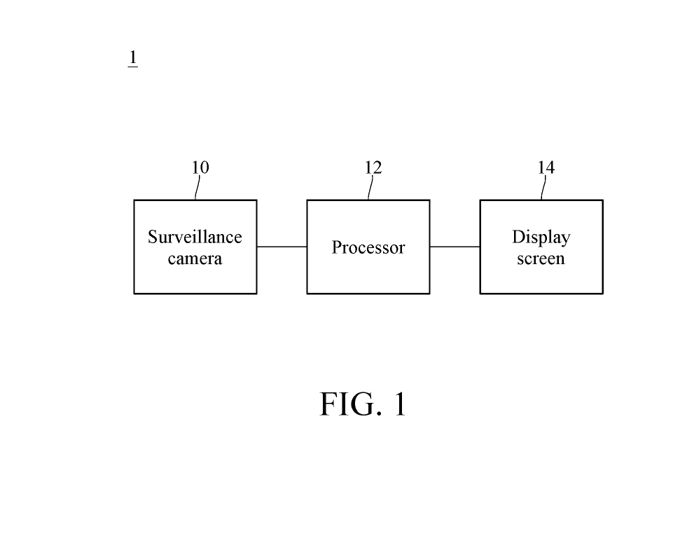

Please refer to FIG. 1. FIG. 1 is a functional block diagram of a surveillance system 1 in an embodiment. The surveillance system 1 includes a surveillance camera 10, a processor 12, and a display screen 14. The processor 12 is electrically connected to the surveillance camera 10 and the display screen 14. The surveillance system 1 can monitor a space, for example, not limited to an indoor space or an outdoor space. The surveillance system 1 divides the space into multiple sub-spaces to be monitored, and each of the sub-spaces to be monitored includes at least one preset region. In other words, the surveillance system 1 monitors the space by monitoring the preset regions. In practice, the sizes of the sub-spaces to be monitored are varied based on their preset regions. Also, the disclosure has no limitations on the number of sub-spaces to be monitored and the number of preset regions in each of the sub-spaces to be monitored.

The surveillance camera 10 is used to capture images of the preset regions in the sub-spaces to be monitored and transmit the images to the display screen 14 for the display. For example, the surveillance camera 10 is not limited to a mechanical camera, such as a pan-tilt-zoom (PTZ) camera, a pan-tilt (PT) camera or etc., or a wide-angle camera, such as a fisheye camera, a panoramic camera, a digital PTZ (ePTZ) camera or etc. If the surveillance camera 10 is a mechanical camera, the surveillance camera 10 mechanically changes its photographing direction to capture the images of the preset regions in the space in order, and the surveillance camera 10 only captures the image of one preset region (i.e. a fraction of the entire image of the space) per a time point. Alternatively, if the surveillance camera 10 is a wide-angle camera whose field of view covers all the preset regions, the surveillance camera 10 can simultaneously capture the images of all the preset regions in the space (i.e. the panoramic image of the space) at any time point.

The processor 12 is used to control the surveillance camera 10. When an object appears in a certain preset region, the processor 12 controls the surveillance camera 10 to track the object in the sub-space to be monitored corresponding to the preset region. In other words, the processor 12 is used to perform the surveillance method promoted in the disclosure, and the surveillance method will be illustrated in detail later. For example, the processor 12 is not limited to be disposed within the surveillance camera 10 or be disposed in a remote computing device outside the surveillance camera 10.

In response to the control of the processor 12, the display screen 14 displays the images captured by the surveillance camera 10. In an embodiment, if the surveillance camera 10 is a fisheye camera, because images captured by fisheye camera are distorted, the processor 12 first de-warps these images and then displays the de-warped images on the display screen 14. Therefore, supervisors may easily observe a specific portion of the displayed image.

The following embodiments of the surveillance method are illustrated in detail below.

### First Embodiment of Surveillance Method

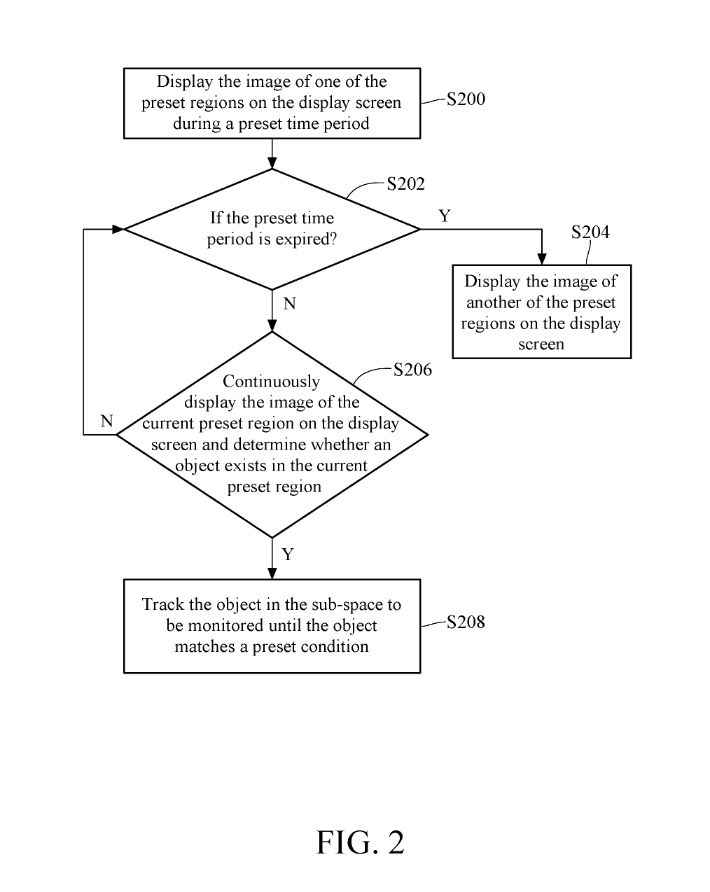

Please refer to FIG. 1 and FIG. 2. FIG. 2 is a flow chart of a surveillance method in an embodiment. The surveillance method includes the following steps. In step S200, display the image of one of the preset regions on the display screen 14 during a preset time period. For example, if the surveillance camera 10 is a mechanical camera, the surveillance camera 10 captures the images of the preset regions in the space in order and transmits the images to the display screen 14 in order for display. Alternatively, if the surveillance camera 10 is a wide-angle camera, the surveillance camera 10 simultaneously captures the images of all the preset regions in the space, the display screen 14 displays each of the images in a preset order. In an embodiment, a display time period, for which the image of one preset region is displayed on the display screen 14, is the preset time period in step S200.

Moreover, if the surveillance camera 10 is a mechanical camera, multiple patrol points (referred to as preset patrol points) are set for the surveillance camera 10 before step S200 is performed, and each of the patrol points corresponds to one of the preset regions. Accordingly, the surveillance camera 10 can patrol these patrol points one by one according to the preset order to capture the scene at the patrol point, and the display screen 14 displays the images of the preset regions one by one according to the preset order and the preset time period. In this or some embodiments, the preset order corresponds to the sequence of the patrol points.

In step S202, determine whether the display time period, for which the image of one of the preset regions is displayed on the display screen 14, exceeds the preset time period. If the display time period exceeds the preset time period, the method proceeds to step S204; and if the display time period has not exceeded the preset time period, the method proceeds to step S206.

In an embodiment, the preset time period is varied in accordance with a different preset region so the display time period for the display screen 14 to display one image is varied in accordance with a different preset region corresponding to the displayed image. That is, the preset regions have their respective preset time period. For example, when the display time period, for which the display screen 14 displays the image of the first preset region, exceeds the first preset time period (e.g. 5 seconds) corresponding to the first preset region, the display screen 14 displays the image of the second preset region instead of the image of the first preset region; and when the second preset time period (e.g. 8 seconds) corresponding to the second preset region ends, the display screen 14 displays the image of a next preset region (i.e. the third preset region) instead of the image of the second preset region. The operation related to the rest of the preset regions can be deduced by analogy.

In step S204, display the image of another of the preset regions on the display screen 14. In step S206, continuously display the image of the current preset region on the display screen 14 and determine whether the object still exists in the current preset region. When the object still exists in the current preset region, the method proceeds to step S208; and when no object exists in the current preset region, the method returns to step S202. In an embodiment, if the above patrol points have been set for the surveillance camera 10 operating in a patrol mode and a decision that the surveillance camera 10 has focused on a certain patrol point for a time exceeding the preset time period corresponding to the current preset region is made in step S202, the surveillance camera 10 adjusts its lens to focus on a next patrol point according to the preset order of the patrol points in step S204, whereby the image of the preset region corresponding to the next patrol point can be displayed on the display screen 14.

Finally, in step S208, the surveillance camera 10 tracks the object in the sub-space to be monitored corresponding to the current preset region until the object matches a preset condition. In an instance, a preset region is the field of view (FOV) of the surveillance camera 10 focusing on a patrol point, and a sub-space to be monitored is a region for tracking an object if the object appears in the preset region. In an embodiment, the sub-space to be monitored is larger than or equal to the related preset region. Embodiments of the preset condition include that the object leaves the sub-space to be monitored corresponding to the current preset region, that the preset time period corresponding to the current preset region ends, or a combination thereof. In an embodiment, when the surveillance camera 10 tracks the object appearing in the sub-space to be monitored corresponding to the current preset region, the object is shown in the center of the image displayed on the display screen 14 until the object fits in the above preset condition.

In an embodiment, the surveillance method further includes counting a respective number of times that the object appears in each of the preset regions. When the preset time period is expired in step S202, the image of the present region in which the object appears for the maximum number of times will be displayed on the display screen 14 in step S204. In an embodiment, if the above patrol points has been set for the surveillance camera 10 operating in the patrol mode, the aforementioned preset order in the patrol mode is set according to the number of times that the object appears in a respective preset region so that the image of the preset regions are captured according to the preset order. In an example, when the processor 12 determines that the number of times that the object appears in the first preset region is greater as compared to the second preset region, the surveillance camera 10 in the patrol mode will first capture the image of the first preset region and then capture the image of the second preset region.

Embodiments of the surveillance method with respect to the various preset conditions in step S208 are described in detail below.

### Second Embodiment of Surveillance Method

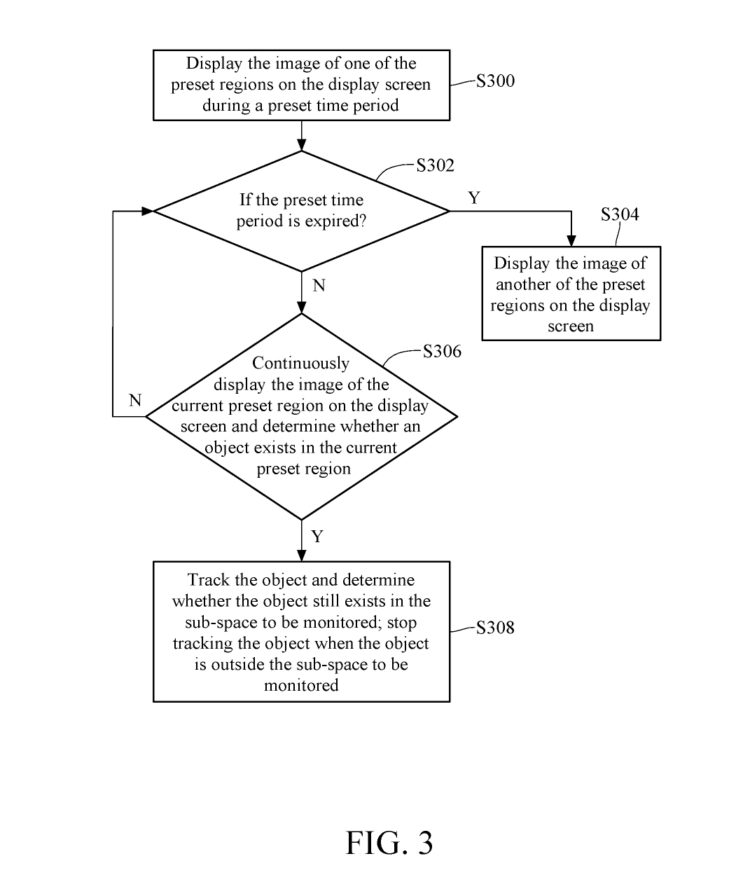

Please refer to FIG. 3. FIG. 3 is a flow chart of a surveillance method in another embodiment. The steps S300 to S306 in FIG. 3 are the same as the steps S200 to S206 in FIG. 2, respectively and thus, will not be repeated hereinafter. In step S308, the surveillance camera 10 tracks the object and the processor 12 determines whether the object still exists in the sub-space to be monitored corresponding to the current preset region. If the object leaves the sub-space to be monitored, the surveillance camera 10 stops tracking the object; and if the object still exists in the sub-space to be monitored, the surveillance camera 10 continuously tracks the object until the object leaves the sub-space to be monitored.

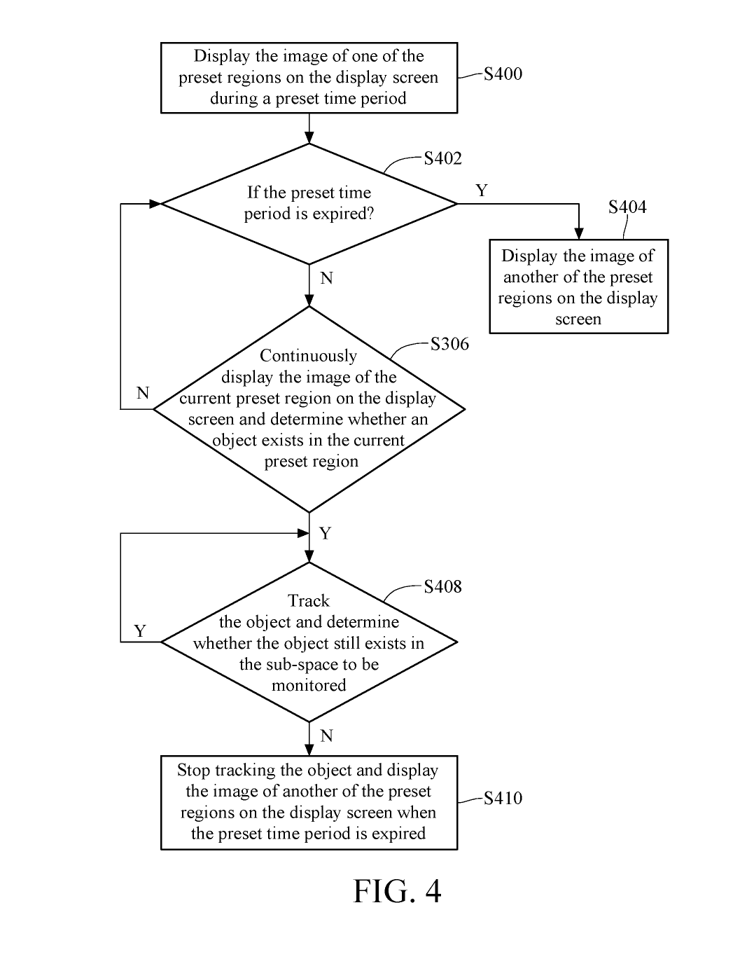

Please refer to FIG. 4. FIG. 4 is a flow chart of a surveillance method in yet another embodiment. Steps S400 to S406 in FIG. 4 are the same as steps S200 to S206 in FIG. 2 respectively and will not be repeated hereinafter. In step S408, the surveillance camera 10 tracks the object and the processor 12 determines whether the object still exists in the sub-space to be monitored corresponding to the current preset region. If the object still exists in the sub-space to be monitored corresponding to the current preset region, the method returns to step S408; and if the object leaves the sub-space to be monitored corresponding to the current preset region, the method proceeds to step S410.

In step S410, the surveillance camera 10 stops tracking the object, and the image of another of the preset regions is displayed on the display screen 14 when the preset time period corresponding to the current preset region is expired. In other words, the preset condition in the second embodiment of the surveillance method is that the object leaves the sub-space to be monitored corresponding to the current preset region. The second embodiment of the surveillance method has the limitation in the tracking region.

### Third Embodiment of Surveillance Method

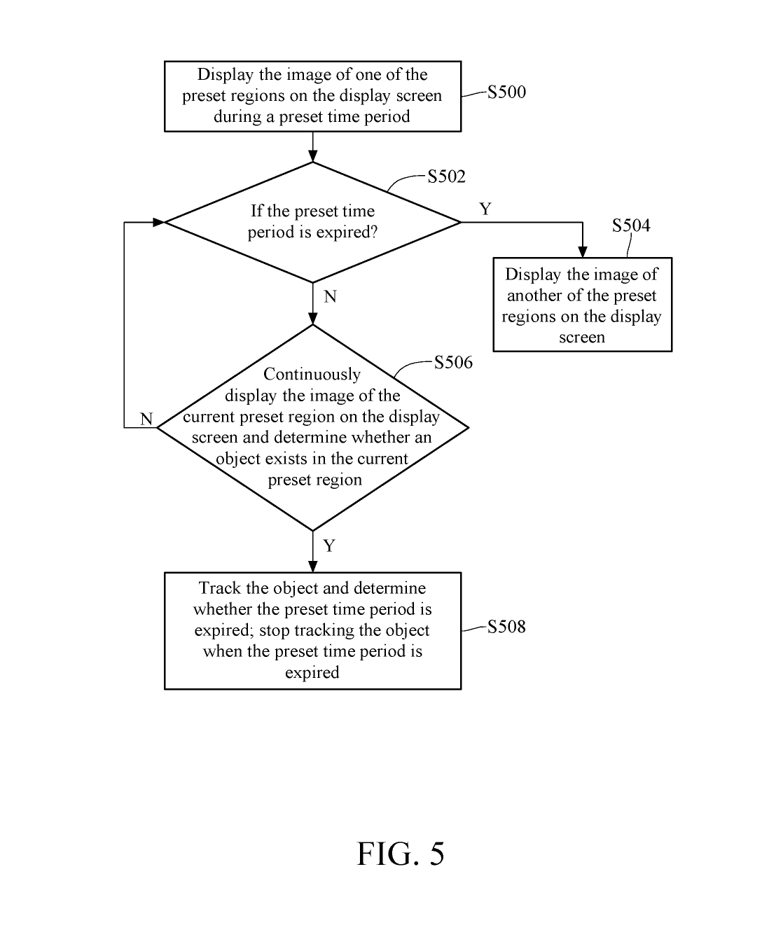

Please refer to FIG. 5. FIG. 5 is a flow chart of a surveillance method in yet another embodiment. Steps S500 to S506 in FIG. 5 are the same as steps S200 to S206 in FIG. 2 respectively and thus, will not be repeated hereinafter. In step S508, the surveillance camera 10 tracks the object and the processor 12 determines whether the preset time period is expired. If the preset time period is expired, the surveillance camera 10 stops tracking the object. If the preset time period has not been expired, the method returns to step S508.

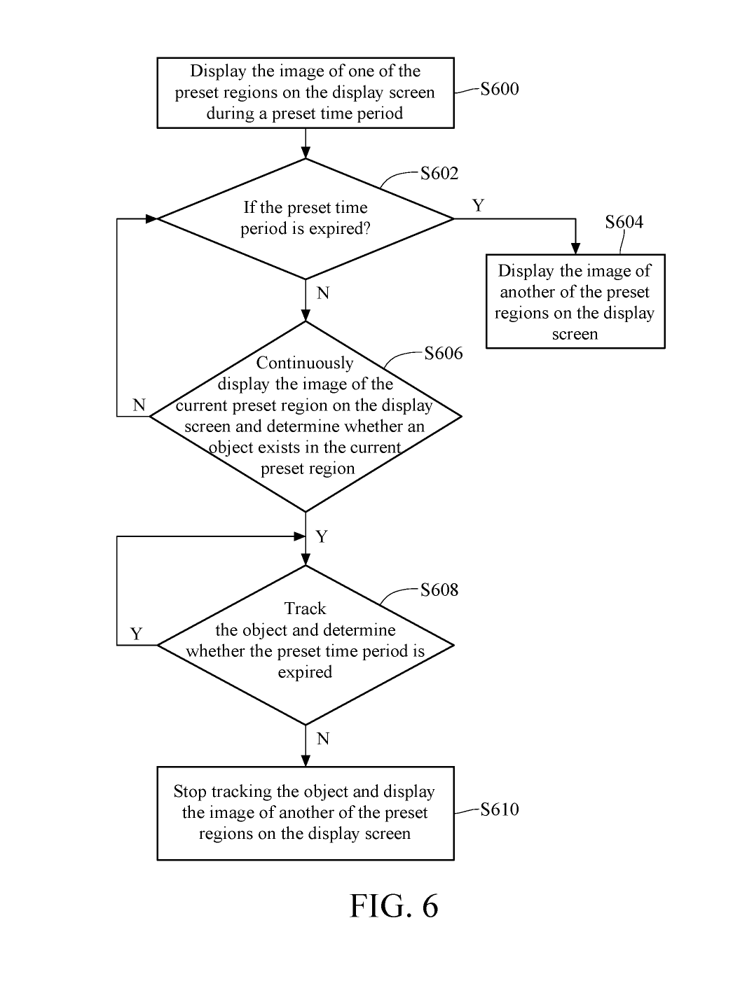

Please refer to FIG. 6. FIG. 6 is a flow chart of a surveillance method in yet another embodiment. Steps S600 to S606 in FIG. 6 are the same as steps S200 to S206 in FIG. 2 respectively and thus, will not be repeated hereinafter. In step S608, the surveillance camera 10 tracks the object and the processor 12 determines whether the preset time period, which corresponds to the current preset region, which the object appears in, is expired. If this preset time period has not been expired, the method returns to step S608; and if this preset time period is expired, the method proceeds to step S610. In step S610, the surveillance camera 10 stops tracking the object, and the image of another of the preset regions is displayed on the display screen 14.

Accordingly, the preset condition in the third embodiment of the surveillance method is that the total time, which is spent by the surveillance camera 10 to capture the image of the current preset region covering the object, is over the preset time period corresponding to the current preset region. In this or some embodiments, such a determination is performed starting from step S600. In other words, the third embodiment of the surveillance method has the limitation in tracking time.

### Fourth Embodiment of Surveillance Method

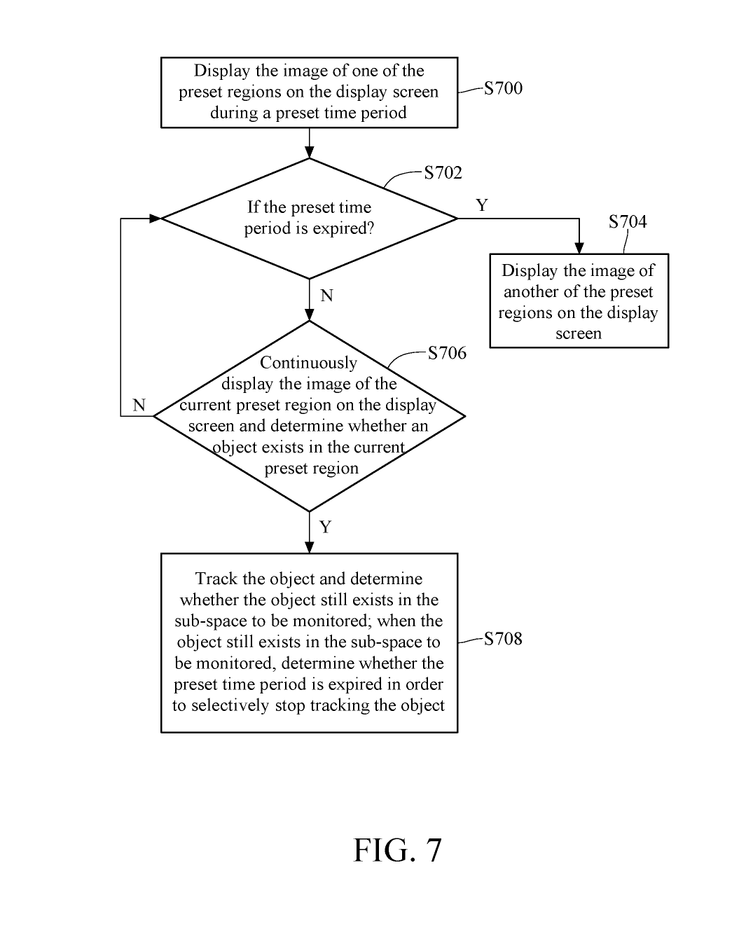

Please refer to FIG. 7. FIG. 7 is a flow chart of a surveillance method in yet another embodiment. Steps S700 to S706 in FIG. 7 are the same as steps S200 to S206 in FIG. 2 respectively and thus, will not be repeated hereinafter. In step S708, the surveillance camera 10 tracks the object and the processor 12 determines whether the object still exists in the sub-space to be monitored corresponding to the current preset region. If the object still exists in this sub-space to be monitored, continuously track the object and determine whether the preset time period is expired, in order to decide whether to stop tracking the object.

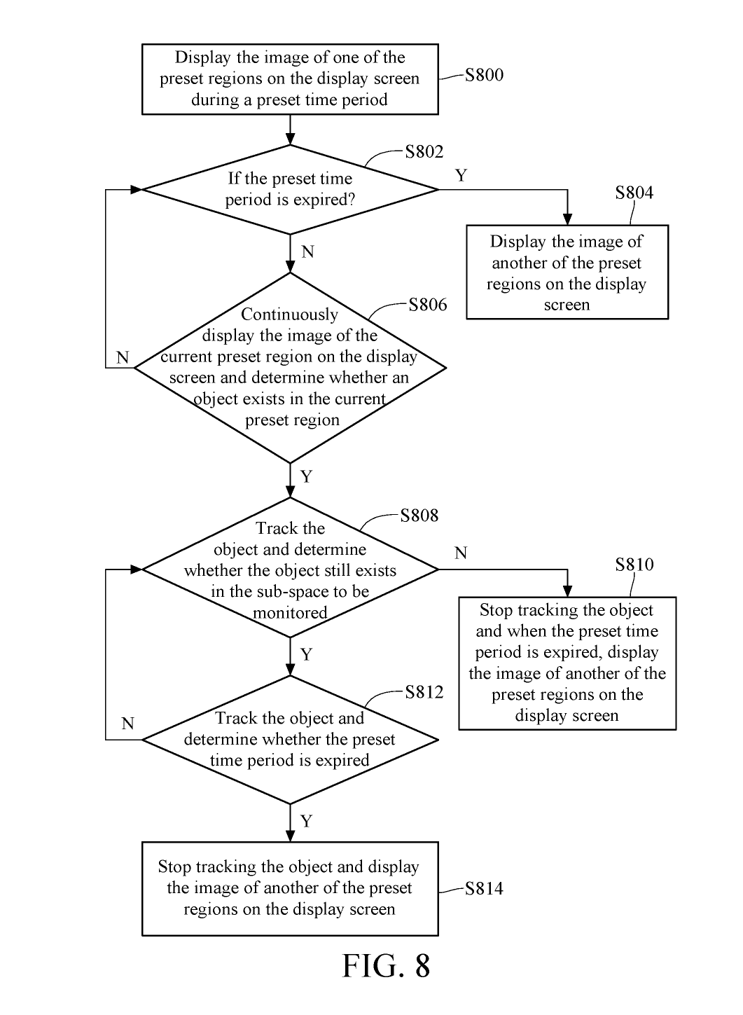

Please refer to FIG. 8. FIG. 8 is a flow chart of a surveillance method in yet another embodiment. Steps S800 to S806 in FIG. 8 are the same as steps S200 to S206 in FIG. 2 respectively and thus, will not be repeated hereinafter. In step S808, the surveillance camera 10 tracks the object and the processor 12 determines whether the object still exist in the sub-space to be monitored corresponding to the current preset region. If the object leaves this sub-space to be monitored, the method proceeds to step S810; and if the object still exists in this sub-space to be monitored, the method proceeds to step S812.

In step S810, the surveillance camera 10 stops tracking the object, and when the preset time period is expired, the display screen 14 displays the image of another of the preset regions. In step S812, the surveillance camera 10 keeps tracking the object and the processor 12 keeps determining whether the preset time period corresponding to the current preset region is expired. If the preset time period corresponding to the current preset region where the object still appears, the method returns to step S808; and if this preset time period is expired, the method proceeds to step S814. In step S814, the surveillance camera 10 stops tracking the object and sends the image of another of the preset regions to the display screen 14 for display.

Accordingly, the fourth embodiment of the surveillance system method employs two preset conditions. One preset condition is that the object leaves the sub-space to be monitored corresponding to the current preset region, and the other preset condition is that the total time for the surveillance camera 10 to capture the image of the current preset region where the object appears is over the preset time period corresponding to the current preset region. In other words, the fourth embodiment of the surveillance method has limitations in both tracking range and tracking time.

Performance of the Disclosure

The surveillance method and surveillance system promoted in the disclosure can be applied to mechanical cameras and wide-angle cameras functioning as surveillance cameras and employ the surveillance camera to monitor a space including multiple preset regions. When the surveillance camera is used to monitor these preset regions, the display screen displays the image of one of the preset regions per a respective preset time period. Meanwhile, the disclosure also continuously determines whether the time spent on displaying the image of one of the preset regions on a display screen is over such a preset time period, so as to keep displaying the image of the current preset region on the display screen or to display the image of another preset region on the display screen.

Moreover, when the display screen is controlled to keep displaying the image of the current preset region, a decision whether any object appears in the current preset region may be made. If yes, the surveillance camera may track the object in a suitable range until the object fits in a preset condition.

Therefore, when the display screen is displaying the image of each of the preset regions in order, the disclosure may also detect whether any object appears in the current preset region, may track an object appearing in a preset region. Furthermore, the disclosure adds the limitations in tracking region, tracking time, or a combination thereof, so the disclosure can be applied to different environments having various surveillance requirements.

For instance, if the disclosure is applied to the indoor space of a bank or post office, the setting of the tracking range (referred to as a sub-space to be monitored) corresponding to a preset region covering at least a fraction of the bank door or post door may be based on the door in order to photograph clear images of visitors' faces. For another instance, if the disclosure is applied to the outer space like a street or an entrance, the preset time periods corresponding to the preset regions each covering at least a fraction of the street or the entrance are relatively short in order to photograph images related to all events occurring on the street or at the entrance.

Accordingly, the disclosure may enhance the safety of surveillance systems and have relatively high practicability.

What is claimed is:

1. A surveillance method of monitoring a space, which is divided into a plurality of sub-spaces to be monitored each comprising at least one preset region, by a surveillance camera configured to capture images of the preset regions to be displayed on a display screen, and the surveillance method comprising:
displaying the image of one of the preset regions on the display screen during a preset time period;
determining whether an object exists in the preset region when the image of the preset region is being displayed on the display screen;
controlling the surveillance camera to track the object existing in the sub-space to be monitored until the object matches a preset condition, when the object exists in the preset region during the preset time period;
determining whether the preset time period has ended;
unceasingly displaying the image of the preset region on the display screen when the preset time period has not ended; and
displaying the image of another of the preset regions on the display screen when the preset time period ends.

2. The surveillance method according to claim 1, wherein the preset condition is that the object is outside the sub-space to be monitored, and when the object exists in the preset region during the preset time period, the surveillance method further comprises:
tracking the object and determining whether the object still exists in the sub-space to be monitored; and
stopping tracking the object when the object is outside the sub-space to be monitored.

3. The surveillance method according to claim 1, wherein the preset condition is that the preset time period ends, and when the object is in the preset region during the preset time period, the surveillance method further comprises:
tracking the object and determining whether the object is still in the sub-space to be monitored; and
when the object is still in the sub-space to be monitored, unceasingly tracking the object and determining whether the preset time period ends in order to selectively stop tracking the object.

4. The surveillance method according to claim 1, wherein the preset condition is that the preset time period ends, and the surveillance method further comprises:
tracking the object and determining whether the preset time period ends when the object exists in the preset region during the preset time period; and
stopping tracking the object when the preset time period ends.

5. The surveillance method according to claim 1, wherein sizes of the plurality of sub-spaces to be monitored are varied based on the preset regions, and a length of the preset time period is varied based on each of the preset regions.

6. The surveillance method according to claim 1, wherein before one of the images of the preset regions is displayed on the display screen, the surveillance method further comprises:
setting patrol points for the surveillance camera, and each of the patrol points corresponding to one of the preset regions;
controlling the surveillance camera to patrol and select each of the patrol points in a preset order and capture the image of the selected patrol point; and
displaying the image of one of the preset regions on the display screen according to the preset order and the preset time period.

7. The surveillance method according to claim 6, further comprising: displaying the image of next one of the preset regions on the display screen when the preset time period ends according to the preset order.

8. The surveillance method according to claim 6, further comprising:
counting a number of times that the object exists in the preset regions respectively,
wherein the preset order is set according to the numbers of times, and the images of the preset regions are captured according to the preset order.

9. The surveillance method according to claim 1, further comprising:
counting a number of times that the object exists in the preset regions respectively; and
displaying the image of the preset region, where the object appears for a maximum number of times, on the display screen when the preset time period ends.

10. The surveillance method according to claim 1, wherein before the image of one of the preset regions is displayed on the display screen during the preset time period, the surveillance method further comprises:
de-warping the image of one of the preset regions captured by the surveillance camera.

11. A surveillance system for monitoring a space that is divided into sub-spaces to be monitored each comprising at least one preset region, and the surveillance system comprising:
a surveillance camera configured to capture images of the preset regions; and
a processor electrically connected to the surveillance camera and configured to a surveillance method that comprises:
displaying one of the images of the preset regions on a display screen during a preset time period;
determining whether an object exists in the preset region when the image of the preset region is being displayed on the display screen;
controlling the surveillance camera to track the object existing in the sub-space to be monitored until the object matches a preset condition, when the object exists in the preset region during the preset time period;
determining whether the preset time period ends;
unceasingly displaying the image of the preset region on the display screen when the preset time period has not ended; and
displaying the image of another of the preset regions on the display screen when the preset time period ends.

12. The surveillance system according to claim 11, wherein the surveillance camera is a wide-angle camera having a field of view covering the preset regions.

13. The surveillance system according to claim 11, wherein the preset condition is that the object is outside the sub-space to be monitored, and when the object exists in the preset region during the preset time period, the surveillance method further comprises:
tracking the object and determining whether the object still exists in the sub-space to be monitored; and
stopping tracking the object when the object is outside the sub-space to be monitored.

14. The surveillance system according to claim 11, wherein the preset condition is that the preset time period ends, and when the object is in the preset region during the preset time period, the surveillance method further comprises:
tracking the object and determining whether the object is still in the sub-space to be monitored; and
when the object is still in the sub-space to be monitored, unceasingly tracking the object and determining whether the preset time period ends in order to selectively stop tracking the object.

15. The surveillance system according to claim 11, wherein the preset condition is that the preset time period ends, and the surveillance method further comprises:
tracking the object and determining whether the preset time period ends when the object exists in the preset region during the preset time period; and
stopping tracking the object when the preset time period ends.

16. The surveillance system according to claim 11, wherein sizes of the plurality of sub-spaces to be monitored are varied based on the preset regions, and a length of the preset time period is varied based on each of the preset regions.

17. The surveillance system according to claim 11, wherein before one of the images of the preset regions is displayed on the display screen, the surveillance method further comprises:
setting patrol points for the surveillance camera, and each of the patrol points corresponding to one of the preset regions;
controlling the surveillance camera to patrol and select each of the patrol points in a preset order and capture the image of the selected patrol point; and
displaying the image of one of the preset regions on the display screen according to the preset order and the preset time period.

18. The surveillance system according to claim 17, further comprising: displaying the image of next one of the preset regions on the display screen when the preset time period ends according to the preset order.

19. The surveillance system according to claim 17, further comprising:
counting a number of times that the object exists in the preset regions respectively,
wherein the preset order is set according to the numbers of times, and the images of the preset regions are captured according to the preset order.

20. The surveillance system according to claim 12, wherein before the image of one of the preset regions is displayed on the display screen during the preset time period, the surveillance method further comprises:
de-warping the image of one of the preset regions captured by the surveillance camera.
